(19) United States
(12) Patent Application Publication
(10) Pub. No.: US 2003/0079357 A1
(43) Pub. Date: May 1, 2003

(54) Level having a detachable securing structure

(76) Inventor: Wen Hsin Liao, Taichung (TW)

Correspondence Address: Wen Hsin Liao, No. 108-24, Chong Chin Road, Bei Tun Chu, Taichung, 406, TW

(21) Appl. No.: 09/984,124

(22) Filed: Oct. 29, 2001

(51) Int. Cl. G01C 9/00

(52) U.S. Cl. 33/374

(57) ABSTRACT

A level includes a level vial device detachably secured to a housing without additional fasteners or tools. A latch is rotatably secured to the housing and has a tongue for selectively engaging with and securing the level vial device to the housing. A seat and a cap are secured to the housing, the latch includes one or more spring legs rotatably secured onto a hub of the cap. The housing includes two side walls engaged with the seat for securing the seat to the plate. One or more bubble vials may further be secured to the plate with two covers.

### BACKGROUND OF THE INVENTION

1. Field of the Invention

The present invention relates to a level, and more particularly to a level having a detachable securing structure.

2. Description of the Prior Art

Various kinds of typical levels have been developed and used today. U.S. Pat. No. 5,519,942 to Webb discloses one of the typical levels including a number of bubble vials solidly engaged or secured in a casing or the like with fasteners, or by welding processes, such that the bubble vials are solidly secured or engaged into the casing and such that the bubble vials may not be detached or disengaged from the casing.

U.S. Pat. No.5,105,549 to Johnson discloses the other typical level including a bubble vial secured to a metal frame with two covers, and a number of fasteners for securing the covers and the metal frame together. It takes a long time to thread and to unthread the fasteners relative to the metal frame and the covers for securing and for disengaging the covers and the metal frame from each other.

The present invention has arisen to mitigate and/or obviate the afore-described disadvantages of the conventional levels.

### SUMMARY OF THE INVENTION

The primary objective of the present invention is to provide a level including a detachable securing structure.

In accordance with one aspect of the invention, there is provided a level comprising a housing, a level vial device, and means for detachably latching the level vial device to the casing without additional fasteners or tools. The level vial device may includes one or more bubble vials disposed therein.

The latching means includes a latch rotatably secured to the housing and having at least one tongue for selectively engaging with and securing the level vial device to the housing. The housing includes a cap secured thereon. the latch is rotatably secured onto the cap.

The cap includes a hub provided therein, the latch includes at least one spring leg extended therefrom and engaged through the hub of the cap and engaged with the hub for rotatably securing the latch to the cap.

The housing includes a plate having an upper portion and a lower portion, and a seat secured to the lower portion of the housing, the cap is engaged onto the upper portion of the plate and secured to the seat.

The seat includes at least one duct formed therein, the cap includes at least one spring-biased catch extended therefrom and engaged into and hooked to the at least one duct for detachably securing the cap to the seat.

The plate includes an opening formed therein, the seat includes a peripheral wall provided therein and extended through the opening of the plate for securing the seat to the plate.

The housing includes two side walls secured to the plate and each having a flange extended therefrom and engaged with the seat for securing the seat to the housing.

The housing includes a plate having an opening formed therein, a bubble vial engaged in the opening of the plate, and two covers secured to the housing and engaged onto the bubble vial for securing the bubble vial to the housing.

The plate includes two notches formed therein and communicating with the opening thereof for receiving ends of the bubble vial. The covers each includes a barrel having at least two recesses formed therein for receiving ends of the bubble vial.

Further objectives and advantages of the present invention will become apparent from a careful reading of a detailed description provided hereinbelow. with appropriate reference to accompanying drawings.

### BRIEF DESCRIPTION OF THE DRAWINGS

FIG. 1 is a perspective view of a level in accordance with the present invention;

FIG. 2 is an enlarged partial perspective view of the level;

FIGS. 3, 4 are partial exploded views of the level;

FIG. 5 is a cross sectional view taken along lines 5-5 of FIG. 1;

FIG. 6 is a cross sectional view taken along lines 6-6 of FIG. 5; and

FIG. 7 is a cross sectional view taken along lines 7-7 of FIG. 2.

### DETAILED DESCRIPTION OF THE PREFERRED EMBODIMENT

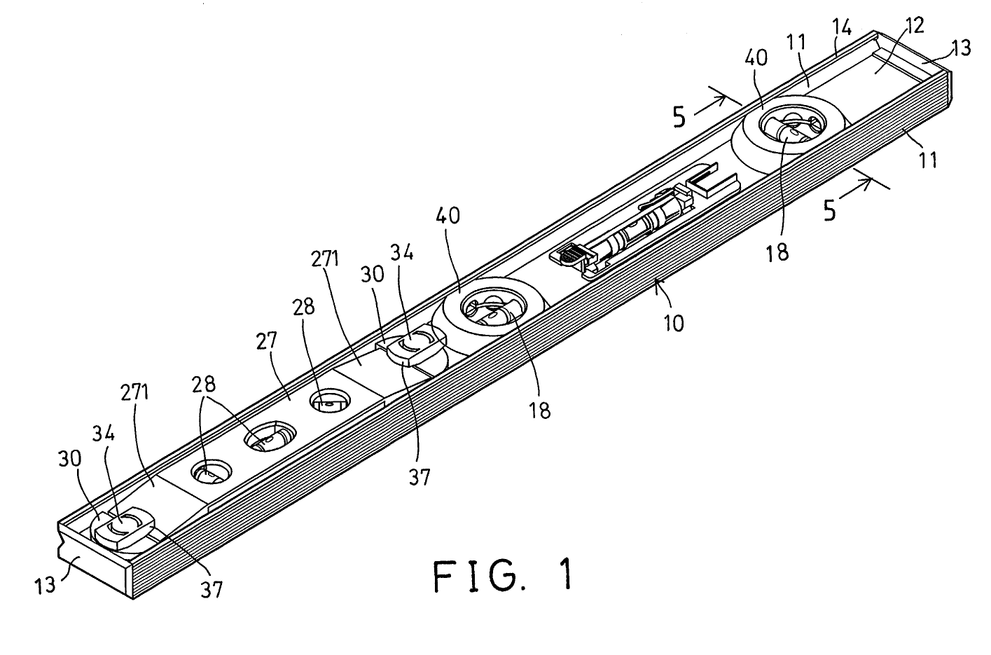

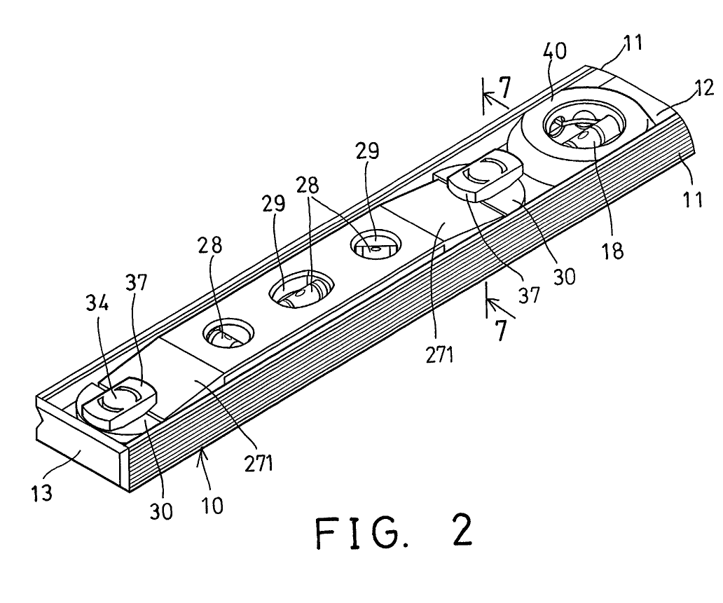

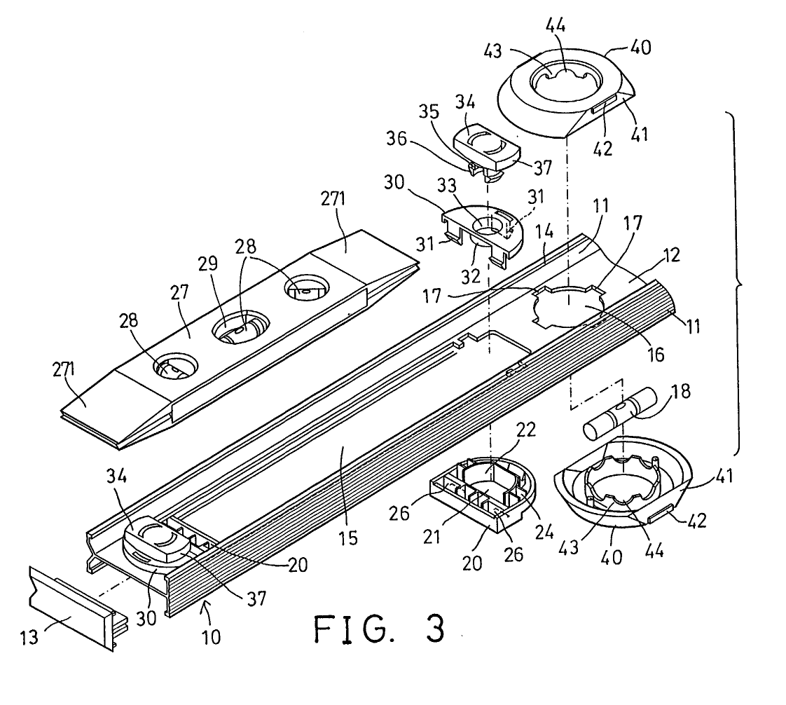

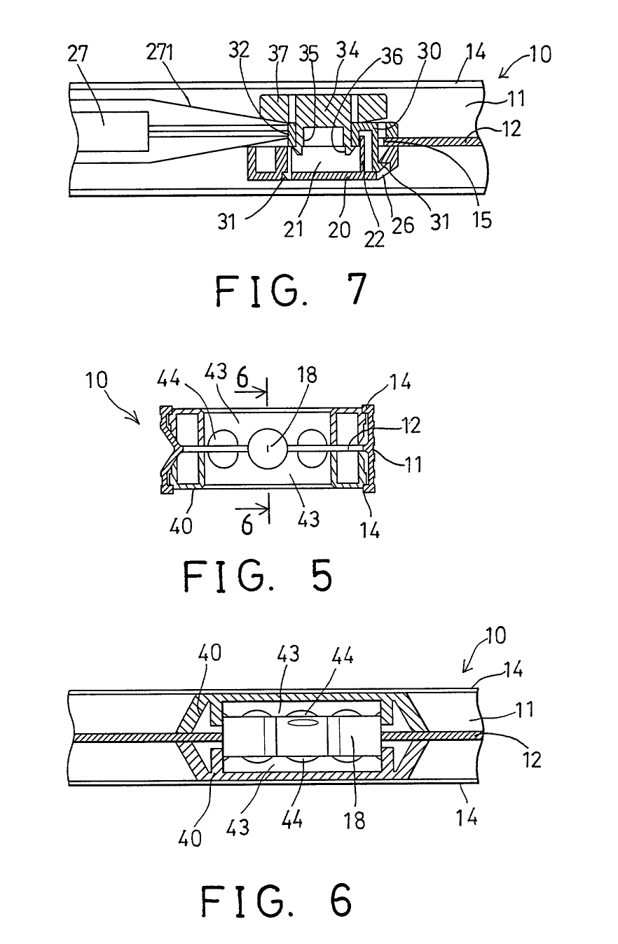

Referring to the drawings, and initially to FIGS. 1-5, a level in accordance with the present invention comprises a housing 10 including a pair of side walls 11 each having two flanges 14 formed in the upper and the lower portions thereof, a plate 12 provided or extended or disposed or secured between the middle portions of the side walls 11, and two end walls 13 secured to the ends of the side walls 11 and the plate 12. The housing 10 includes one or more openings 15, 16 formed therein, and one or more notches 17 formed therein and communicating with the opening 16 for receiving bubble vials 18 therein.

One or more seats 20, such as two seats 20 are engaged onto the bottom portion of the plate 12 and located close to the ends of the opening 15 of the housing 10, and each has an aperture 21 formed therein and defined by a peripheral wall 22 and one or more reinforcing ribs 24 that are extended upward from the seats 20 and engaged into the ends of the opening 15 of the housing 10, for securing the seats 20 to the housing 10 with such as a force-fitted engagement. The seats 20 preferably include two sides engaged with the side walls 11 and the flanges 14 for allowing the seats 20 to be further solidly secured to the housing 10. The seats 20 each includes one or more ducts 26 formed therein.

One or more, such as two caps 30 are engaged onto the upper portion of the plate 12, and each includes one or more spring-biased catches 31 extended downward therefrom and engaged through the opening 15 of the housing 10 and engaged into and hooked to the respective ducts 26 of the seats 20, for detachably securing the caps 30 to the plate 12 and the seats 20 without additional fasteners and tools. The caps 30 each includes a downward extending hub 32 extended inward of the aperture 21 of the seat 20 and having a cavity 33 formed therein.

A level vial device 27 includes two end engaged onto and supported on the seats 20 and includes one or more bubble vials 28 received or engaged therein, and one or more windows 29 aligned with the bubble vials 28 for allowing the bubble vials 28 to be seen through the windows 29. One or more, such as two latches 34 each includes one or more spring legs 35 extended downward therefrom and rotatably engaged into the cavity 33 of the cap 30 and each having a catch 36 engaged with the hub 32 for rotatably securing the latch 34 to the cap 30. The latch 34 includes one or more tongues 37 selectively engaged with the inclined ends 271 of the level vial device 27 (FIGS. 1, 2, 7) for detachably securing the level vial device 27 to the housing 10, by rotating the latch 34 relative to the housing 10, without additional fasteners and tools. The latch 34 may also be rotated relative to the housing 10 to disengage the tongues 37 from the level vial device 27, for allowing the level vial device 27 to be easily disengaged from the housing 10. The level vial device 27 may thus be easily and quickly engaged into and disengaged from the housing 10 without additional fasteners and tools.

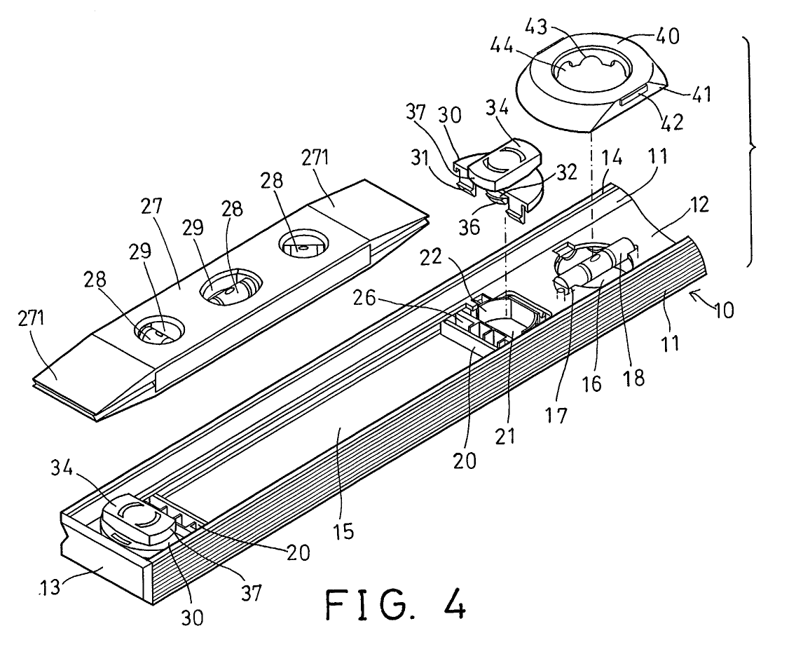

One or more pairs of covers 40 are engaged onto the upper and the lower portions of the plates 12 and each has two flat surfaces 41 engaged with the side walls 11 and two juts 42 engaged with the flanges 14, such that the covers 40 may be secured between the side walls 11 of the housing 10. The covers 40 each includes a barrel 43 having a number of recesses 44 for receiving the ends of the bubble vials 18 (FIGS. 4-6), and for securing the bubble vials 18 to the plate 12 of the housing 10.

It is to be noted that the level vial device 27 may include one end directly engaged into a recess of the housing 10 or hooked to the housing 10. without the rotatable latch 34. A single latch 34 may be rotatably secured onto the housing 10 and selectively engaged with the other end of the level vial device 40 for selectively and detachably securing the other end and thus the level vial device 27 to the housing 10.

Accordingly, the level in accordance with the present invention includes a detachable securing structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A level comprising:
a housing,
a level vial device, and
means for detachably latching said level vial device to said casing.

2. The level according to claim 1, wherein said latching means includes a latch rotatably secured to said housing and having at least one tongue for selectively engaging with and securing said level vial device to said housing.

3. The level according to claim 2, wherein said housing includes a cap secured thereon, said latch is rotatably secured onto said cap.

4. The level according to claim 3, wherein said cap includes a hub provided therein, said latch includes at least one spring leg extended therefrom and engaged through said hub of said cap and engaged with said hub for rotatably securing said latch to said cap.

5. The level according to claim 3, wherein said housing includes a plate having an upper portion and a lower portion, and a seat secured to said lower portion of said housing, said cap is engaged onto said upper portion of said plate and secured to said seat.

6. The level according to claim 5, wherein said seat includes at least one duct formed therein, said cap includes at least one spring-biased catch extended therefrom and engaged into and hooked to said at least one duct for detachably securing said cap to said seat.

7. The level according to claim 5, wherein said plate includes an opening formed therein, said seat includes a peripheral wall provided therein and extended through said opening of said plate for securing said seat to said plate.

8. The level according to claim 5, wherein said housing includes two side walls secured to said plate and each having a flange extended therefrom and engaged with said seat for securing said seat to said housing.

9. The level according to claim 1, wherein said housing includes a plate having an opening formed therein, a bubble vial engaged in said opening of said plate, and two covers secured to said housing and engaged onto said bubble vial for securing said bubble vial to said housing.

10. The level according to claim 9, wherein said plate includes two notches formed therein and communicating with said opening thereof for receiving ends of said bubble vial.

11. The level according to claim 9, wherein said covers each includes a barrel having at least two recesses formed therein for receiving ends of said bubble vial.
